(19) United States
(12) Patent Application Publication
(10) Pub. No.: US 2020/0087149 A1
(43) Pub. Date: Mar. 19, 2020

(54) METHOD FOR THE SYNTHESIS OF NANOFLUIDS

(71) Applicant: RESEARCH INSTITUTE OF PETROLEUM INDUSTRY, Tehran (IR)

(72) Inventors: Zeinab TALAEI, Tehran (IR); Alimorad RASHIDI, Tehran (IR); Azadeh AMROLLAHI BIYOUKI, Tehran (IR); Allreza MAHJOUB, Tehran (IR); Roghayyeh LOTFI, Tehran (IR); Maryam RASHTCHI, Tehran (IR)

(73) Assignee: RESEARCH INSTITUTE OF PETROLEUM INDUSTRY, Tehran (IR)

(21) Appl. No.: 15/743,236

(22) PCT Filed: Jul. 22, 2015
(86) PCT No.: PCT/IB2015/001161

§ 371 Date: Jan. 9, 2018

(51) Int. Cl. C01B 32/174; C01B 32/18; C01B 32/194; C01B 32/20; C01B 32/156; B01F 11/02

(52) U.S. Cl. CPC C01B 32/174; C01B 32/18; C01B 32/194; B82Y 40/00; C01B 32/156; B01F 11/02; C01B 32/20

(57) ABSTRACT

The present invention relates to a method for the synthesis of nanofluids including functionalization of carbon nanostructures through a new method comprising the addition of carbon nanostructures to water; ultrasonication of the solution; addition of persulfate salt and one or several metal hydroxides of the first column of the periodic table to the aqueous solution containing carbon nanostructure; re-exposing the solution to ultrasonic waves; and then, the separation of the functionalized carbon nanostructures from the solution and washing the carbon nanostructures with water to neutralize them and mixing the nanoparticles obtained from the previous step with the fluid. By presenting a new method for the synthesis of the functionalized carbon nanostructures with specific amount of functional groups and their application in the synthesis of nanofluids, an increase in the stability and thermal conductivity of nanofluids takes place.

### TECHNICAL FIELD

The present invention relates to nanofluids containing functionalized carbon nanostructures. It also relates to a method for the synthesis of nanofluids containing functionalized carbon nanostructures and the nanofluids thus obtained. By presenting a new method for the synthesis of functionalized carbon nanostructures at a specific amount of functional groups and their application in the synthesis of nanofluids, an increase in stability, thermal property (conductive and convection heat transfer) and rheological property of nanofluids takes place.

### BACKGROUND OF THE INVENTION

The energy crisis in the world today is an important issue that due to an increase in the world population and an increasing reduction in fossil fuel resources as well as environmental pollutions resulting from industrialization, it has directed researchers to find renewable and environmentally-friendly resources of energy and make the optimal use of them. This way, the application of new and nano materials in the fields of energy production, storage and saving can lead to improvements.

For example, it can be pointed to nanofluid and nano-insulator issues in energy saving where by the use of nanomaterials in nanofluids, a reduction takes place in the size of heat exchangers and also in the consumption of the exchanger fluid (e.g. water, ethylene glycol, and a mixture of water and ethylene glycol) in different industries. The initial goals of the research and development of nanofluids are to discover the unique properties of nanoparticles for the development of heat transfer fluids containing stable dispersed particles with high thermal conductivity. The thermal conductivity of traditional heat transfer fluids like lubricants, engine coolants, and water is low by nature. The use of nanofluids relative to suspensions containing particles of millimeter and micrometer in size enjoys benefits such as improved heat transfer and stability; cooling of microchannels; minimum clogging; possibility of minimizing the systems; saving on energy and cost; and reduction of pump power. Two general methods are employed to prepare nanofluids. One of them is the old two-stage method by which the nanoparticles are first made and then they are dispersed in the base liquid phase. The second method is a new one-stage method by which nanoparticles are directly made and dispersed in the base phase simultaneously. The two-stage methods are more conventional and more cost-effective than the one-stage methods. The two-stage methods can be used for the production of nanofluids with nanoparticles and different base fluids; while, the one-stage methods are mostly applied for the production of nanofluids containing metals or metal oxides in fluids with low vapor pressure. The preparation of nanofluids by the two-stage method is not as simple as the preparation of the common liquid/solid mixtures. The very serious problem that threatens the ideas of preparing nanofluids, is the agglomeration of the nanoparticles in the fluid which is further increased in nano-scale parallel to the reduction of the particle size.

The common methods used for having access to stable nanofluid without being agglomerated are acidity change, functionalization of the surface of particles, use of surface active agents, and ultrasonic vibrators. All the methods affect the surface properties of suspension in a way to prevent the formation of clusters and form stable suspension. Research activities show that among the methods mentioned, functionalization of the surface of the particles and their dispersion by ultrasonic waves enjoy the best efficacy from the view of both thermal properties and stability in nanofluids. The application of chemicals like surfactants affects the thermal properties and the use of acid or base materials destroy some of the initial properties of fluids. Of the most important factors effective in the preparation of nanofluids is to obtain suitable nanoparticles for which there are different methods for preparation of the nanoparticles: chemical vapor condensation (CVC), mechanical abrasion, chemical vapor deposition, and sol-gel. Research activities have shown that each of these methods has better efficacy for the preparation of specific nanoparticle with special application and of course, the preparation of nanoparticles and its methods of preparation are part of the new issues of research for scientists. Water, ethylene glycol, engine oil, silicon oil, and acetone are used as base fluid to prepare thermal nanofluids; both metallic and nonmetallic nanoparticles are also used in the preparation of nanofluids. With regard to the fact that carbon nanotubes have been proved to be good heat conductors of nanofluids, many research activities are being performed on them. To produce nanofluids containing carbon nanotubes, a stable suspension of carbon nanotubes should first be prepared; this job is done by the production of hydrophilic functional groups on the surface of carbon nanotubes. The carbon nanotubes have very high thermal conductivity by nature, but their problem in the preparation of nanofluids is their very low stability in fluids. Basically, some defects are generated on the surface of the nanotubes by functionalization enhancing their stability in fluids. Since the high thermal conductivity and high stability of nanoparticles in fluids are very important in thermal nanofluids, therefore no destruction of the carbon structure and generation of satisfactory defects in the nanotubes are required to have high thermal conductivity and stability. Among existing functional groups, the use of carboxylic and hydroxylic groups is important due to their low cost relative to other functional groups, such as silver, sulfonate and so on. The papers and the patents related to functionalization process of the surface of carbon nanoparticles are presented in this account. Then, the current methods for the production of nanofluids containing carbon nanostructures with high thermal conductivity are presented here. The operating conditions employed in these documents are in a manner that the amount of surface destruction of the carbon nanostructure is minimized. In the methods presented in these documents, a percentage of the functional groups of carboxylic and hydroxylic are introduced on the surface of the nanoparticles. But, each of these documents suffers some drawbacks compared with our invention which will be pointed to sequentially:

One of the methods of chemical improvement for the opening the end of carbon nano-tubes is to immerse the carbon nanotubes in a mixture of sulfuric and nitric acids. In this method, the carboxylic groups bond to the open end of the carbon nanotubes. This method whose results are printed in Science, Vol. 280, May 22, 1998 p. 1253-1256, reports on the destruction of nanoparticle surface; it also reports of a high amount of functional groups. The results are qualitatively plotted in Thermogravimetric Analyzer (TGA) and Raman graphs. The reaction temperature was also risen up to 90° C. and the ultrasonic 59 kHz waves were also used. Additionally, by the use of acid, no moderate conditions are generated for the functionalization of the particles. Also, the Transmission Electron Microscopy (TEM) image shows the destruction of the particles.

The carbon nanotubes are in contact with a strong oxidizing factor like nitric or sulfuric acids for sufficient time in patent application WO1996018059 so that the surface of the carbon nanotubes are oxidized and then the surface of the carbon nanotubes is in contact with a suitable reagent to specify the amount of functional group by titration method where about 6-10 mmol/gr of the functional group is introducted onto the nanostructure. By this method as an alternative process, the hydrophilic functional groups are introducted on the surface of carbon nanotubes. In this invention, the use of an acid at 80-90° C. does not provide moderate operating conditions for the reaction and its control at higher scales is difficult. There is no mention of the stability of dispersion and destruction of the surface of the particles in the patent.

A method is revealed for the purification and functionalization of the synthesized carbon nanotubes containing carbon impurities like carbon nanoparticles and amorphous carbons in U.S. Pat. No. 5,698,175. This method consists of the ultrasonication of carbon nanotubes in nitric acid, chlorosulfonic acid and/or heating carbon nanotubes in potassium permanganate and sulfuric acid for the purification of carbon nanotubes or introduction of functional groups on carbon nanotubes. Regarding the high temperature of above 150° C. in this invention, the operating conditions are not suitable with regard to temperature and working conditions with acid and permanganate. The time used in this invention is a 60 minute period for ultrasonication. No mention is made of the stability of dispersion and destruction of the surface of particles in this patent.

Other methods for the introduction of hydrophilic groups on carbon nanotubes are the use of UV waves (U.S. Ser. No. 11/088,320); use of microwaves (U.S. Ser. No. 11/374,499); generation of phenyl sulfonated groups (U.S. Ser. No. 11/516,426); and use of ozone gas (U.S. Ser. No. 10/701,402) which are uneconomical and with low yield. Also, the ozone method does not contribute to the purification of the nanostructures; therefore, functionalizing the nanostructures prepared through chemical method (e.g. production of carbon nanotubes by CVD method) by ozone method is not suitable due to the impure residuals.

In patent application US2008/0302998, Hong et al. presented the effect of different types of cationic, anionic, amphoteric, nonionic surfactants, etc. on the solubility of hybrid carbon nanotubes and metal oxides in hydrophilic thermal fluids and no significant increase has been reported. Also, a comparison was made between this method and the introduction of hydrophilic groups on carbon nanotubes and its effect on thermal properties. According to this application, addition of about 0.05% by weight of carbon nanotube to fluid, the thermal conductivity is increased about 6 to 11%. In the application, the increases of 1 and 8% in thermal conductivity respectively for water/ethylene glycol and water with 0.1% by weight of sulfonated carbon nanotube have been reported.ln this method surfactants which lose their properties at temperatures higher than 50-70° C. are used.

Also, in another patent application (US2007/0158610), the same scientists worked on hydrophilic thermal fluids and different types of carbon nanotubes; the results of the base fluid PAC (Prestone antifreeze coolant) regarding the nanotubes functionalized by the acid method of 3:1 and sodium dodecyl benzene sulfonate (SDBS) surfactant, no significant difference was shown for thermal conductivity. In this method, 6-11% of increase was observed in thermal conductivity relative to the base fluid. Also, these surfactants are not stable at high temperatures.

In another patent application (US2007/0158609), these scientists worked on oil-base fluids and different types of surfactants; the results of the DURASYN-base fluid and the double walled carbon nanotube as well as OLOA showed an increase of 10% in thermal conductivity. In this application, nanoparticles are ultrasonicated for about 10 to 30 minutes for the dispersion of agglomerates.

In patent U.S. Pat. No. 7,348,298, an increase in the thermal conductivity of fluids containing graphite nanoparticle and carbon nanotubes is investigated. Different chemical dispersants to disperse carbon nanotubes are employed. About 25% increase is observed in conductivity. Surfactants are inefficient for the use of nanofluids in high thermal applications due to the generation of van der Waals forces between the nanoparticles and surfactant and also their instability at different temperatures; additionally, by an increase in the rate of corrosion in the base fluid, the stability properties disappear. There is no mention of surface destruction of particles in this patent.

In patent U.S. Pat. No. 6,695,974, carbon nanomaterials are used to enhance thermal conductivity in fluids. To enhance the thermal conductivity of the fluid, carbon nanotubes containing covalently bonded polar organic groups are used. In example 5, first double walled carbon nanotube was functionalized using acid method, and then the compound was added in one vol. % to ethylene glycol. About 37% increase in heat transfer ability including both conduction and convection has been reported. It is obvious that an increase in the amount of carbon nanotubes in nanofluid up to specific level will increase the amount of heat transfer. The use of surfactants for preparing the nanofluid is also cited in this patent.

Surfactants are inefficient for the use of nanofluids in high thermal applications due to the generation of van der Waal forces between nanoparticles and surfactant as well as their instability at different temperatures. Also, by an increase in the rate of corrosion in the base fluid, the stability properties disappear. No mention is made of the destruction of the surface of particles in this patent.

In a method, Liu et al. (Liu M.-S., Lin M. C. C and Huang I.-T. Enhancement of thermal conductivity with carbon nanotube for nanofluids [Journal]//International communication in heat and mass transfer.—2005.—Vol. 32.—pp. 1202-1210.) used ethylene glycol and synthetic engine oil as base fluids for preparing carbon nanotubes nanofluids. N-hydroxysuccinimide (NHS) was used for the dispersion of synthetic oil-carbon nanotube suspensions. NHS is in the form of solid particles and was directly added to carbon nano-tubes. The mixture was blended by a magnetic stirrer and the engine oil was poured on the CNTs-NHS mixtrue. The mixture was mixed up by ultrasonic homogenizer. The experiment was done with ethylene glycol base fluid, without surfactant. For CNT-ethylene glycol suspensions at a volume fraction of 0.01 (1 vol. %), thermal conductivity increased up to 12.4%. On the other hand, for CNT-synthetic engine oil suspensions, thermal conductivity increased by 30% at a volume fraction of 0.02 (2 vol. %).

After many trial and error experiments, Ding et al. (Heat transfer of aqueous suspensions of carbon nanotubes (CNT nanofluids) International journal of heat and mass transfer.-2006.—Vol. 49.—pp. 240-250.) found that sodium laurate (SL), sodium dodecyl benzene sulfonate (SDBS), and gum Arabic (GA) could keep nanotubes in a stable state for more than one month without observing significant sediment. The method was as follows: A: placing the sample of carbon nanotubes in an ultrasonic bath for over 24 hours. B: dispersing the carbon nanotubes in a specific amount of distilled water containing gum Arabic and pH adjustment of suspension. C: homogenizing the mixture with homogenizer of high shear force for 30 minutes. It was observed that the nanofluids obtained by this method were stable for several months. Surfactants were used for this purpose showing less stability of dispersion compared to functionalization methods. The maximum increase of the thermal conductivity does not exceed 18% for 0.1% CNT nanofluids.

Hwang et al. (Investigation on characteristics of thermal conductivity enhancement of nanofluids [Journal]//Current Applied Physics.—2006.—Vol. 6.—pp. 1068-1071.) used sodium dodecyl sulfate (SDS) as a surfactant to produce water—multi walled carbon nanotube nanofluid. Surfactants were also used for this research showing less stability of dispersion compared to functionalization methods.

The thermal conductivity enhancement of water-based MWCNT nanofluid is increased up to 11.3% at a volume fraction of 0.01.

Many methods for the functionalization of carbon nanotubes including reflux, heating, and/or stirring are performed over long periods of time. For example, for the introduction of carboxylic acid groups on carbon nanotubes, the carbon nanotubes should be refluxed for several hours and/or for acyl chlorination and/or amidation, and/or 1,3-dipolar cycloaddition requires several days of reflux or heating which is not cost-effective in both time and energy.

Although the hydrophilic groups are introduced on carbon nanotubes by the use of sulfuric and nitric acids, the tubal structure of carbon nanotubes suffer cutting damage resulting in thermal conduction reduction. The use of high temperature in preparing thermal nanofluids is another disadvantage of this method; additionally, great care should be taken when using nitric and sulfuric acids. Also, the use of nitric and sulfuric acids in great amount is not economical. The neutralization stage of the functionalized nanostructures is not only time-consuming, but it is also accompanied with specific problems of dissolving the filter inside acid. Additionally, the use of nitric acid and/or sulfuric acid in functionalization of carbon nanotubes leads to corrosion. Also, due to the high concentration of acid at the stage of neutralization, the passage of nanostructures through the filters is inevitable and very time-consuming. What is to be addressed for nanofluids in all the cases of functionalization of carbon nanostructure and introduction of hydrophilic functional groups on the surface of these nanostructures is the non-destructivity of the structure and an increase in thermal conduction as well as an increase in stability.

### SUMMARY OF THE INVENTION

This invention provides a new method for functionalization of carbon nanostructure which is more efficient compared to other methods of functionalization of the surface of carbon nanostructure in non-destructivity of nanomaterials, their functionalization with a suitable percentage of functional groups and an increase in stability and thermal property especially thermal conductivity of nanofluid. For example, the multi-walled carbon nanotubes functionalized according to the present invention may result in a 58% increase in the thermal conductivity of water-based nanofluids. In this method, the carbon nanostructure is first functionalized. The carbon nanostructures in the present invention are selected from among one or several carbon materials including carbon nanotubes, carbon nanofiber, nanohorns, graphite, graphene, and fullerene. The method of functionalizing carbon nanostructure is performed in a manner that the carbon nanostructure is first ultrasonicated in water and then a suitable amount of one or more persulfate salts (like sodium persulfate, potassium persulfate and/or ammonium persulfate) and one or more metal hydroxides of the first column of the periodic table are added to it and exposed to ultrasound wave, e.g. at room temperature for 10 to 40 minutes.

Then, the functionalized carbon nanostructures are separated e.g. by filtration and washed with distilled water up to neutral acidity. One of the goals of the present invention is to enhance the efficiency of introduction of hydrophilic groups on carbon structure without causing damage of cutting type with suitable percentage of functional group on the surface of these materials for the use in different processes including nanofluids. Another goal of this invention is to present an economical method for the synthesis of thermal and/or rheological nanofluids. This is done by a reduction in operational costs with no use of corrosive materials (acids) to prevent damage to equipment; to moderate operating conditions for the functionalization of the surface of carbon nanostructures by the use of persulfate salt and metal hydroxide (the process of the functionalization of the surface of carbon nanostructures preferably is performed at ambient temperature); and a reduction in functionalization process time of carbon nanomaterials. The use of persulfate salt and reduction of the activation energy of reaction in a moderate oxidation lead to the reduction of temperature: Due to the absence of surfactant in the preparation of stable suspension containing carbon nanostructure in water, this method enjoys high priority. That is because surfactants lose their properties at high temperatures and an increase in water hardness brings about instability in nanofluids. The most important difference between functionalized nanostructures prepared according to this method and functionalized nanostructures prepared based on other methods is the nondestructiveness of nanostructures with a suitable percentage of functional groups. One of the most important advantages of this process is that it is possible to produce high-quality carbon nanostructures with high economic value due to their special uses in nanofluids and their growing application in different industries. This method of functionalization leads to the production of pure nanotubes with high surface area to volume ratio of the particles. As is also observed in the electronic image (FIG. 4), this method purifies the nanostructures without damaging them (cutting). In this method, due to the uniform presence of hydrophilic agent on the surface of the nanostructures, these nanostructures are distributed suitably and are not agglomerated in the fluid. Compared to other methods, this method is easier and more cost-effective (due to low operating temperature and no use of acids with any corrosion problems). Of other important advantages of this invention is the production of nanofluids at low frequency (e.g. 40 KHz) and low temperature of ultrasonic bath (e.g. 25° C.) within little time being ultrasonicated (e.g. 15 minutes in case of not using the ultrasound in the mixing step of functionalized carbon nanostructures with fluid and 25 minutes in case of using it) resulting in the reduction of operating costs. High stability of nanostructures is another important advantage of this invention when using these functionalized nanostructures in thermal fluids. In the present method according to the present invention, the nanostructures pass the neutralization step faster than common methods for synthesizing nanostructures due to preservation of structure and easiness of filtration process.

### DETAILED DESCRIPTION OF THE INVENTION

The present invention provides a method for the synthesis of nanofluids including functionalization of carbon nanostructures. The method comprises the addition of carbon nanostructures to water; ultrasonication of the solution; addition of one or more persulfate salts and one or more metal hydroxides of the first column of the periodic table to the aqueous solution containing carbon nanostructure; reexposing the solution to ultrasonic waves; separation of the functionalized carbon nanostructures from the solution; washing the carbon nanostructures with water to neutralize them; and mixing the nanoparticles obtained from the previous step with the fluid.

The persulfate salt is present in the aqueous solution preferably in an amount of from 5 to 50% by weight of water, more preferably 5 to 20% by weight and most preferred 5% to 10% by weight.

The carbon nanostructures are present in the aqueous solution preferably in an amount of from 0.01 to 1% by weight of water, more preferably 0.01 to 0.1% by weight and most preferred 0.05 to 0.1% by weight.

In the method according to the present invention, the metal hydroxides are added to the aqueous solution preferably in an amount of from 5 to 50% by weight of water.

In the first step of ultrasonication, the aqueous solution containing carbon nanostructure is exposed to ultrasound wave preferably for 5 to 15 minutes.

In the second step of ultrasonication, the aqueous solution containing carbon nanostructure is exposed to ultrasound wave preferably for 10 to 40 minutes.

In the functionalization step, ultrasonication is preferably done in the frequency range of 40-59 kHz. In the method according of the present invention, the functionalization of carbon nanostructures is preferably performed at ambient temperature (from 20 to 30° C.).

According to the present invention, the fluid can be a hydrophilic fluid (e.g. water, alkylene glycols and combinations thereof) or a hydrophobic fluid (e.g. oils such as silicone oil and engine oil). According to the present invention the fluid can be a drilling mud, drilling fluid, oil well cement or blood.

Further, the alkylene glycol can be ethylene glycol or diethylene glycol.

According to the present invention, the obtained nanoparticles may be mixed to the fluid in an amount of from 0.01 to 1% by weight of nanofluid.

According to the present invention, the persulfate salt may be selected from persulfate salts such as potassium persulfate, sodium persulfate and ammonium persulfate. According to the present invention, the functionalized carbon nanostructures may be separated from the solution by one or more separating devices like filter or centrifuge. The mixing of functionalized carbon nanostructures and fluid can be done by any device capable of mixing, like ultrasonic and stirrer. According to the present invention, the mixing may be done by ultrasonication for 10-40 minutes within the range of 40-59 KHz frequency. The temperature of the ultrasonic device may be constant at 20-30° C. According to the present invention, mixing by ultrasonication may be done for 10-40 minutes, preferably 10 minutes with time intervals of e.g. every 5 minutes, and then the waves may be interrupted for about 30 seconds and the suspension may be exposed to ultrasound waves in an ultrasonic bath within the range of 40-59 KHz, preferably 40 KHz. The temperature of the ultrasonic device may be 20-30° C. According to the present invention, the functionalized carbon nanostructures may be separated by filter. The carbon nanostructures in this invention are selected from among one or more carbon materials including carbon nano-tubes, carbon nanofiber, nanohorns, graphite, graphene, and fullerene. According to the present invention method, it is possible to dry carbon nanostructures after functionalizing them and then mix them with the fluid in a suitable time and/or another place. In this case, drying can be done by different methods like drying with oven or vacuum oven or freeze drying or supercritical drying methods. According to the present invention, drying may be done at 25 to 40° C.

The graphene can consist of nanographene, single layer graphene, multilayer graphene, graphen nanoribbon and porous graphene.

The carbon nano-tubes can consist of single wall carbon nano-tubes, so-called SWNTs, double wall carbon nano-tubes, so-called DWNTs, and multi wall carbon nano-tubes, so-called MWNTs.

In a preferred aspect of the invention, the applied SWNTs have an average diameter in the range of 1 to 4 nm.

In a preferred aspect of the invention, the applied SWNTs have a pore volume in the range of 0.2 to 1.2 cm ³/g.

In a preferred aspect of the invention, the applied SWNTs have surface areas in the range of 500 to 1500 m ²/g.

In a preferred aspect of the invention, the applied SWNTs have a length in the range of 1 to 100 μm.

In a second preferred aspect of the invention, DWNTs are used as carbon nanostructure.

In this preferred aspect of the invention, the applied DWNTs have an average diameter in the range of 2 to 5 nm.

In another preferred aspect of the invention, the applied DWNTs have a pore volume in the range of 0.2 to 1.2 cm ³/g.

In another preferred aspect of the invention, the applied DWNTs have surface areas in the range of 400 to 700 m ²/g.

In another preferred aspect of the invention, the applied DWNTs have a length in the range of 1 to 100 μm.

In a third preferred aspect of the invention, MWNTs are used as carbon nanostructure.

In this preferred aspect of the invention, the applied MWNTs have an average diameter in the range of 1 to 80 nm.

In another preferred aspect of the invention, the applied MWNTs have a pore volume in the range of 0.2 to 1.2 cm ³/g.

In another preferred aspect of the invention, the applied MWNTs have surface areas in the range of 100 to 500 m ²/g.

In another preferred aspect of the invention, the applied MWNTs have a length in the range of 1 to 100 μm.

In a fourth preferred aspect of the invention, carbon nano-fibers are used as carbon nanostructure.

In this preferred aspect of the invention, the applied carbon nano-fibers have an average diameter in the range of 50 to 100 nm.

In another preferred aspect of the invention, the applied carbon nano-fibers have a pore volume in the range of 0.2 to 0.7 cm³/g.

In another preferred aspect of the invention, the applied carbon nano-fibers have surface areas in the range of 100 to 500 m²/g.

In another preferred aspect of the invention, the applied carbon nano-fibers have a length in the range of 1 to 100 μm.

In a fifth preferred aspect of the invention, carbon nanohorns are used as carbon nanostructure.

In this preferred aspect of the invention, the applied carbon nanohorns have an pore volume in the range of 0.3 to 0.5 cm³/g.

In another preferred aspect of the invention, the applied carbon nanohorns have a pore diameter in the range of 30 to 50 nm.

In another preferred aspect of the invention, the applied carbon nanohorn have surface areas in the range of 200 to 400 m ²/g.

Through the method for the functionalization of nanostructures according to the present invention, a suitable percentage of functional group(s) is introduced without destroying the carbon nanostructures. The functional group(s) are typically introduced at the amount of 2 to 3 wt. % of carbon nanostructures. The functional groups in the present invention are carboxylic and hydroxylic. The most important difference between the functionalized nanostructures prepared based on this invention and the functionalized nanostructures prepared based on other methods is the nondestructiveness of the nanostructures with suitable percentage of the functional group. One of the most important advantages of this method is that it is possible to produce high-quality functionalized carbon nanostructures (suitable distribution of functional groups on the surface of the nanostructure without destroying it) with high economic value due to their special applications in thermal nanofluids and the growing application of these thermal fluids in different industries. Of other important advantages of this invention are the production of nanofluids at low frequency (e.g. 40 KHz) and the low temperature of ultrasonic bath (e.g. 25° C.) over the little time exposed to ultrasonic waves (e.g. 15 minutes in case of not using the ultrasound in the mixing step of functionalized carbon nanostructures with fluid and 25 minutes in case of using it). The high stability of the nanostructures is an important advantage of this invention when using these functionalized nanostructures especially in thermal fluids.

Thermal conductivity of the synthesized nanofluid based on the present invention method is measured by transient hot wire (KD2 Labcell Ltd UK device) and its stability by Malvern Instrument Inc.—Zeta Potential device.

The nanofluids obtained from the method according to the present invention are applicable in all the processes requiring simultaneously thermal property and stable fluids or just stable fluids or rheological property.

### BRIEF DESCRIPTION OF THE DRAWINGS

FIG. 1 shows a scanning electron microscope (SEM) image of carbon nanotubes.

FIG. 2 shoes a SEM image of functionalized carbon nanotubes prepared according to example 1.

FIG. 3 shows a SEM image of functionalized carbon nanotubes prepared according to example 2.

FIG. 4 shows Raman spectra of carbon nanotubes and functionalized carbon nanotubes prepared according to example 2.

FIG. 5 shows Raman spectra of carbon nanotubes and functionalized carbon nanotubes prepared according to example 1.

FIG. 6 shows X-ray diffraction (XRD) patterns of carbon nanotubes and functionalized carbon nanotubes prepared according to example 2.

FIG. 7 shows zeta-potential curves of functionalized carbon nanotubes prepared according to examples 1(A) and 2(B).

FIG. 8 shows thermogravimetric (TGA) curves of carbon nanotubes and functionalized carbon nanotubes prepared according to examples 1(A) and 2(B).

### EXAMPLES

The examples below are given for elaborating the subject-matter of the present invention and the invention is not limited to them.

In all the examples, multi-walled carbon nanotubes of approximate diameter of 1 to 80 nanometers, pore volume of 0.2 to 1.2 cm³/g, surface area of 100 to 500 m²/g, and length of 1 to 100 μm were used. Also, in all the examples, after mixing the functionalized nanostructures with water as a base fluid, the thermal conductivity of suspensions was measured by KD2 Labcell Ltd UK with temperature kept constant by a circulator at 15° C. To compare the thermal conductivity of the nanofluids containing carbon nanotubes and base fluid, water, 50/50 water/ethylene glycol mixture, and ethylene glycol, the thermal conductivity of distilled water, 50/50 water/ethylene glycol mixture, and ethylene glycol were measured by the KD2 device and the values of 0.58 (W/m·K), 0.43 and 0.28 (W/m·K) were obtained, respectively. Their stability was also measured by Malvern Instrument Inc—Zeta Potential.

### Example 1

### Functionalization of Carbon Nanotubes Through Oxidation with Sulfuric and Nitric Acids and Thermal Conductivity Test

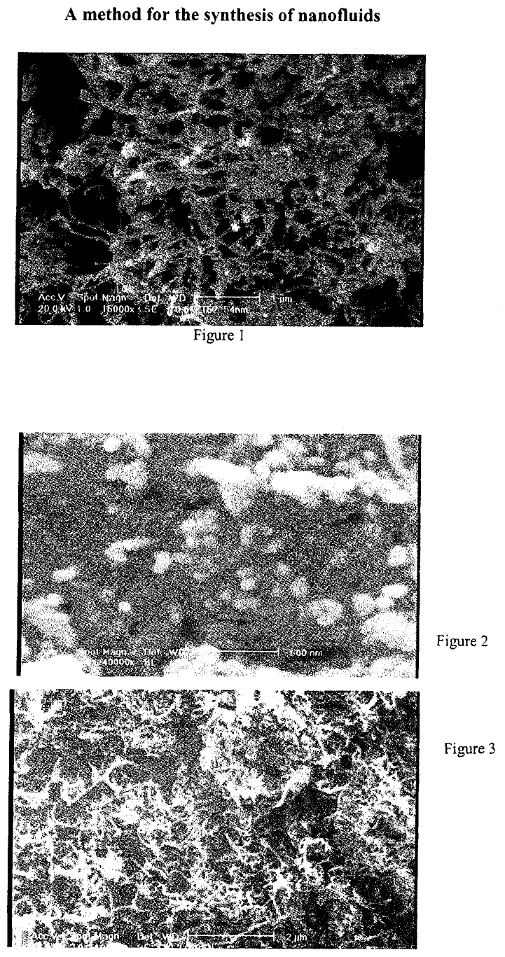

One gram of multi-walled carbon nanotube was added to 40 ml of concentrated mixture of nitric and sulfuric acids (volume ratio of 1 to 3) and was refluxed at a temperature higher than 130° C. for one hour. The nanotubes were then filtered and washed with deionized water to reach a pH of about 7. They were then dried in a 150° C. oven for 12 hours. Then, 0.05-0.1 wt. % of nanofluid, the functionalized carbon nanotubes were added to water and the suspension was exposed to ultrasound waves for 10 minutes in an ultrasonic bath with a frequency of 40 KHz at 20-30° C. The results of functionalization are presented in Table 3. Then, the thermal conductivity of nano-suspensions was measured by the KD2 device at 20° C. The results (Table 1) show an amount of 5 to 13% increase in thermal conductivity. The SEM images of the carbon nanotubes and the functionalized carbon nanotubes are depicted in FIGS. 1 and 2, respectively. The destruction of the structure of multi-walled carbon nanotubes is shown in FIG. 2.

TABLE 1
Measurement results of thermal conductivity of nanofluid containing
functionalized multi-walled carbon nanotubes prepared in example 1

| Wt. % of the | Thermal conductivity | |
|---|---|---|
| functionalized | of | |
| nanotubes in | Base fluid | Thermal conductivity of |
| nanofluid | (W/m · K) | First method (W/m · K) |
| 0.1 | 0.58 | 0.66 |
| 0.05 | 0.58 | 0.61 |

### Example 2

### Functionalization of Carbon Nanotubes Through Oxidation with Potassium Persulfate and Thermal Conductivity Test

To functionalize the carbon nanotubes by the present invention, an aqueous mixture containing 0.01-0.1 wt. % of multi-walled carbon nanotubes was first ultrasonicated for 10 minutes and then, about 20 grams of KPS (potassium persulfate) and 10 grams of KOH (potassium hydroxide) were added to the solution and exposed to ultrasound waves for 10 minutes at ambient temperature. Then, the functionalized carbon nanotubes were separated by a filter and washed with distilled water up to neutral pH. Then, 0.05-0.1 wt. % of nanofluid, functionalized nanotubes were added to water and exposed to ultrasound waves for 10 minutes in an ultrasonic bath with a frequency of 40 KHz at 25° C. The results of functionalization are presented in Table 3. After ultrasonicating the suspensions, the thermal conductivity of the nano-suspensions was measured by KD2 at 20° C. The results (Table 2) show about 43 to 57% increase in thermal conductivity which is a significant increase compared to acid oxidation method (Example 1).

TABLE 2
Measurement results of thermal conductivity of nanofluids containing
functionalized carbon nanotubes prepared in example 2

| Wt. % of the | | |
|---|---|---|
| CCfunctionalized | CCThermal conductivity | |
| nanotubes in | of | Thermal conductivity of 2th |
| nanofluid | Base fluid (W/m · K) | method (W/m · K) |
| 0.1 | 0.58 | 0.91 |
| 0.05 | 0.58 | 0.83 |

FIG. 3 shows the SEM image of functionalized multi-walled carbon nanotubes. This method does not bring about any changes in the tube-shape structure of carbon nanotubes and the tube morphology is preserved like carbon nanotubes prepared through functionalization process.

As it is observed in Table 3, the amount of the carboxylic functional group in functionalized carbon nanotubes prepared through the present invention method is less than that of the acid oxidation method (Example 1). This amount is about 2.3 mmol/g measured through reverse titration.

TABLE 3
Percentage of the carboxylic functional groups introduced on the surface
of multi-walled carbon nanotubes for the first and the second examples

| | The first | |
|---|---|---|
| Experimental data for | method | The second method |
| Carboxylic group concentration | (example 1) | (example 2) |
| Carboxylic group | 6.8 mmol/g | 2.3 mmol/g |
| concentration | | |

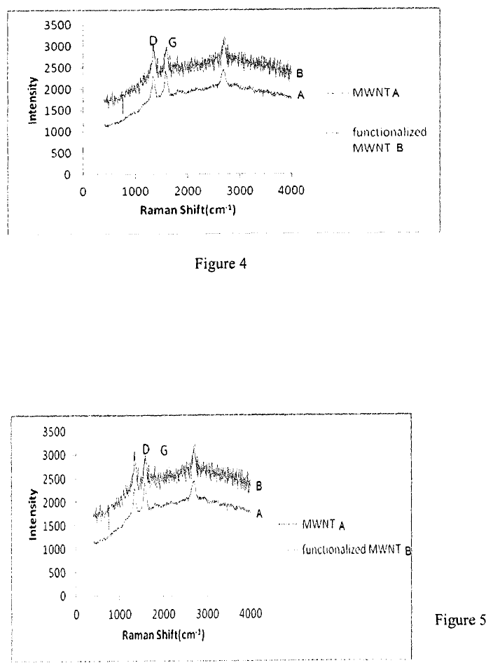

The Raman spectra of the carbon nanotubes and those functionalized by the method in example 2 are compared in FIG. 4. The presence of oscillations in the cm⁻¹ 1500 to cm⁻¹ 1700 region shows the generation of different defects and hybridization change in multi-walled nanotubes.

The intensity ratio of D to G in the functionalized multi-walled carbon nanotubes in this method is 1.03 without destroying the structure of the nanotubes, while this value is 0.92 in the carbon nanotubes. The increase in intensity shows the production of desirable defects in suitable amount (the functional group of carboxylic is one of these defects) on the surface of the nanotubes.

FIG. 5 shows the value of this proportion in the method of sulfuric and nitric acids (with the ratio of three to one) where carbon structural destruction takes place to be 0.95.

The comparison of the results of the Raman spectra along with the results obtained through the reverse titration show that in addition to the production of carboxylic functional groups other defects in example 2 which effectuate more stability of the nanoparticles are also produced on the surface of the nanotubes. The spectrum in FIG. 4 shows that sp² hybridization of the tube-shape structure of carbon nanotubes in persulfate method is changed into sp³ hybridization without destroying the nanotubes; this change has a positive effect on stability and thermal conductivity.

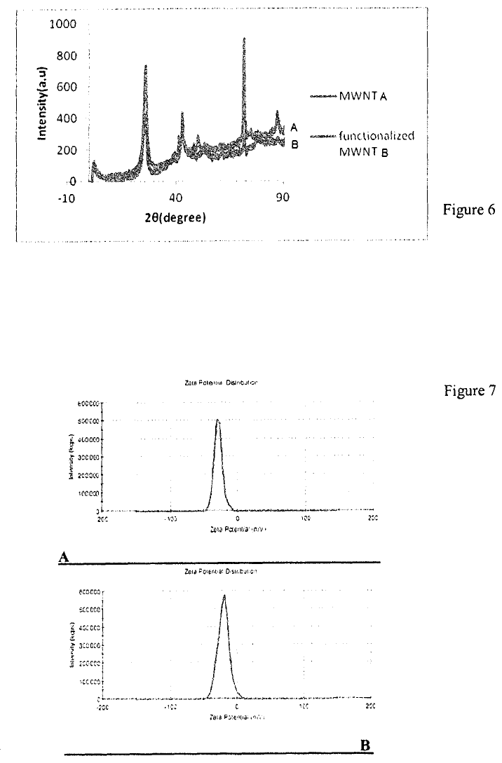

The X-ray diffraction pattern for the multi-walled carbon nanotubes and functionalized multi-walled carbon nanotubes in example 2 are shown in FIG. 6. As it is observed, the intensity of the C (002) peak for the oxidized carbon nanotubes has increased. Also, the peak intensity at 70°, related to the catalyst particles remaining from the synthesis of the carbon nanotubes, is greatly reduced, showing an increase in purity after oxidation operations. On the other hand, this pattern is indicative of the non-destruction of the structures of carbon nanotubes after functionalization.

In general, this method is the first method for the functionalization of carbon nanotubes at ambient temperature causing an increase in theremal conductivity by 57%. Of the main advantages of this method is an increase in thermal conductivity along with more stability of the functionalized carbon nanotubes. The zeta potential curves are presented for the first and the second examples in FIG. 7. The values for the first and the second method is −20.1 and −28.9, respectively. As it is known, the higher absolute value of zeta shows the higher stability rate of the particles, while in this invention in addition to stability, the structure of the carbon nanotubes is not cut denoting the high rate of thermal conductivity.

The SEM images and curves of zeta potential show that the stability was not singly enough for thermal conductivity and that the amount of the nanostructures destruction was also effective.

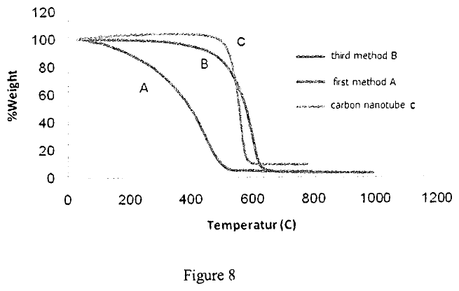

FIG. 8 shows the curve for the thermal properties of nanostructure in which the amount of the nanostructures destruction through acid method results in steeper gradient on the curve, while the matching of the TGA curves of the carbon nanotubes and functionalized carbon nanotubes according to example 2 denotes no destruction of the nanostructures and the existing mild slope in the diagram is related to the functional groups introduced.

### Example 3

### Functionalization of The Carbon Nanotubes Through Oxidation with Sodium Persulfate and Thermal Conductivity Test

Based on the present invention, an aqueous mixture 0.01-0.1% of carbon nanotubes was first ultrasonicated for 10 minutes and then about 20 grams of sodium persulfate (Na₂S₂O₈) and 10 grams of potassium hydroxide (KOH) were added to it and ultrasonicated at ambient temperature for 20 minutes. The functionalized carbon nano-tubes were then separated by a filter and washed with distilled water to neutralize their acidity, and then dried in oven at 60° C.

Thermal Conductivity Test:

0.01 grams of the functionalized multi-walled carbon nanotube were added to 10 to 20 milliliters of distilled water. It was then exposed to ultrasound waves for 10 minutes in an ultrasonic bath with a frequency of 40 KHz at 25° C. The value of thermal conductivity was 0.92 (W/m·K) displaying a 58% increase with the zeta value of −28.9 showing its very high stability.

0.01 grams of the functionalized multi-walled carbon nanotube were added to 10 to 20 milliliters of distilled water. It was then exposed to ultrasound waves for 10 minutes in an ultrasonic bath with a frequency of 40 KHz at 25° C. The value of thermal conductivity was 0.85 (W/m·K) displaying about a 46% increase.

### Example 5

### Functionalization of Carbon Nanotubes Through Oxidation with Persulfate Ammonium and Thermal Conductivity Test

On the basis of the present invention, an aqueous mixture containing 0.01-0.1 wt. % of multi-walled carbon nanotubes were ultrasonicated for 10 minutes and then about 20 grams of APS (Ammonium persulfate) (NH₄) ₂S₂O₈ were added and ultrasonicated for 20 minutes at ambient temperature. Then, the functionalized carbon nanotubes were separated through a filter, washed with distilled water until the acidity was neutralized and dried in oven at 60° C.

Thermal conductivity test:

0.01 grams of the functionalized multi-walled carbon nanotube were added to 10 to 20 milliliters of distilled water. It was then exposed to ultrasound waves for 10 minutes in an ultrasonic bath with a frequency of 40 KHz at 25° C. The value of thermal conductivity was 0.91 (W/m·K) displaying about a 57% increase. The zeta value was −28.9 showing its very high stability.

0.01 grams of the functionalized multi-walled carbon nanotube were added to 10 to 20 milliliters of ethylene glycol. It was then exposed to ultrasound waves for 10 minutes in an ultrasonic bath with a frequency of 40 KHz at 25° C. The value of thermal conductivity was 0.32 (W/m·K) displaying a 14% increase relative to ethylene glycol thermal conductivity.

0.01 grams of the functionalized multi-walled carbon nanotube were added to 10 to 20 milliliters mixture of 50% water and ethylene glycol. It was then exposed to ultrasound waves for 10 minutes in an ultrasonic bath with a frequency of 40 KHz at 25° C. The value of thermal conductivity was 0.52 (W/m·K) displaying a 21% increase relative to mixture of 50% water and ethylene glycol thermal conductivity.

0.01 grams of the functionalized multi-walled carbon nanotube were added to 10 to 20 milliliters of distilled water. It was then exposed to ultrasound waves for 10 minutes in an ultrasonic bath with a frequency of 40 KHz at 25° C. . The value of thermal conductivity was 0.84 (W/m·K) displaying a 44% increase.

1. A method for the synthesis of nanofluids comprising the following steps in ascending order:
addition of carbon nanostructures to water;
ultrasonication of the solution;
addition of one or more persulfate salts and one or more metal hydroxides of the first column of the periodic table to the aqueous solution of carbon nanostructures;
reexposing the solution to ultrasonic waves;
separation of the functionalized carbon nanostructures from the solution;
washing the carbon nanostructures with water to neutralize them to provide nanoparticles; and
mixing the nanoparticles obtained from the previous step with a fluid, wherein the functionalization of carbon nanostructures is performed at a temperature of from about 20 to about 30° C.

2. The method of claim 1, wherein the amount of persulfate salt is in an amount of at least one of from about 5 to about 50%, from about 5 to about 20%, and from about 5 to about 10% by weight of water existing in the aqueous solution.

3. The method according to claim 1, wherein the amount of carbon nanostructures is in an amount of at least one of from about 0.01 to about 1%, from about 0.01 to about 0.1%, and from about 0.05 to about 0.1% by weight of water existing in the aqueous solution.

4. The method according to claim 1, wherein the metal hydroxides are added to the aqueous solution in an amount of from about 5 to about 50% by weight of water existing in the aqueous solution.

5. The method according to claim 1, wherein the aqueous solution containing carbon nanostructure is exposed to ultrasound wave for about 5 to about 15 minutes in the first step of ultrasonication.

6. The method according to claim 1, wherein the aqueous solution containing carbon nanostructure is re-exposed to ultrasound waves for about 10 to about 40 minutes.

7. The method according to claim 1, wherein ultrasonication is performed in a frequency range of from about 40- to about 59 kHz in the functionalization step.

8. (canceled)

9. The method according to claim 1, wherein the fluid is one of a hydro-philic fluid, and a hydrophobic fluid.

10. The method according to claim 1, wherein the persulfate salt is at least one of potassium persulfate, sodium persulfate, and ammonium persulfate.

11. The method according to claim 1, wherein the carbon nanostructures include at least one of carbon nanotubes, carbon nanofiber, nanohorns, graphite, graphene, and fullerene.

12. The method according to claim 1, wherein the nanoparticles obtained are mixed in an amount of from about 0.1 to about 1 wt. % of nanofluid with the fluid.

13. The method according to claim 1, wherein the mixing of nanoparticles with the fluid is performed by ultrasonication for about 10- to about 40 minutes within a frequency range of from about 40-to about 59 KHz at 20-30° C.

14. The method according to claim 1, wherein the mixing of nanoparticles with the fluid is performed by ultrasonication for about 10- to about 40 minutes, with predetermined time intervals and then waves created by the ultrasonication are interrupted for about 30 seconds and the suspension is exposed to ultrasound waves in an ultrasonic bath having a frequency in a range of about 40- to about 59 KHz, at a temperature of about 20- to about 30° C.

15. (canceled)

16. The method according to claim 9, wherein the hydrophilic fluid is at least one of water, alkylene glycols, and combinations thereof, and wherein the hydrophobic fluid is at least one of silicone oil and engine oil.

17. The method according to claim 14, wherein the ultrasonificaiton is about 10 minutes, the predetermined time intervals is about every 5 minutes, and the ultrasound wave includes a frequency of about 40 KHz.
